(19) United States
(12) Patent Application Publication
(10) Pub. No.: US 2024/0114976 A1
(43) Pub. Date: Apr. 11, 2024

(54) AEROSOL-GENERATING DEVICE WITH HEATER ACTUATION MECHANISM

(71) Applicant: PHILIP MORRIS PRODUCTS S.A., Neuchatel (CH)

(72) Inventors: Robert Emmett, Ingatestone (GB); Houxue Huang, Neuchatel (CH)

(21) Appl. No.: 18/286,061

(22) PCT Filed: Apr. 8, 2022
(86) PCT No.: PCT/EP2022/059501

§ 371 Date: Oct. 6, 2023

(30) Foreign Application Priority Data
Apr. 9, 2021 (EP) 21167582.2

(51) Int. Cl. A24F 42/60; A24F 42/10

(52) U.S. Cl. CPC A24F 42/60; A24F 42/10; H05B 1/0252

(57) ABSTRACT

An aerosol-generating device (3) comprises an axially extending heating chamber (15) configured to at least partially receive an aerosol-generating article (5). The aerosol-generating device (3) further comprises a heater actuation mechanism (47) configured to move between an engaging configuration and a non-engaging configuration. The heater actuation mechanism (47) is configured to act on a heater (7) in the engaging configuration to operate the heater (7) to generate heat. The heater actuation mechanism (47) is configured to not act on the heater (7) in the non-engaging configuration to stop generation of the heat by the heater (7). The heater actuation mechanism (47) comprises an operating element (57). The operating element (57) is configured to be moved to move the heater actuation mechanism (47) from the non-engaging configuration into the engaging configuration. The aerosol-generating device (3) further comprises a blocking mechanism (59). The blocking mechanism (59) is configured to temporarily block a movement of the heater actuation mechanism (47) from the engaging configuration into the non-engaging configuration or from the non-engaging configuration into the engaging configuration.

The present disclosure relates to heating an aerosol-generating article in an aerosol-generating device. The present disclosure relates to managing heat in an aerosol-generating device.

EP 0 858 744 A1 describes a flavor generation piece having a heat conduction tube in which a formed body of solid material for generating a flavor or the like to be inhaled by a user is provided. The flavor generation piece may be inserted into a flavor generation heater so that the heat conduction tube is provided above a gas nozzle for providing a flame. An inner surface of the heat conduction tube is covered with a heat accumulating material layer. The heat accumulating material layer allows a temperature of the formed body in the heat conduction tube to be maintained at a flavor generation temperature for a longer time.

According to an aspect of the present invention, there is provided an aerosol-generating device with an axially extending heating space. The heating space is configured to at least partially receive an aerosol-generating article. The aerosol-generating device comprises a heat receiving surface provided outside of the heating space. The aerosol-generating device comprises a heat storage body and an inner heat conduction body. The heat storage body is provided between the heat receiving surface and the heating space. The inner heat conduction body is provided between the heat storage body and the heating space. A material of the heat storage body has a higher specific heat capacity than a material of the inner heat conduction body. The material of the inner heat conduction body has a higher thermal conductivity than the material of the heat storage body.

The heat storage body may serve as a heat buffer. The heat storage body may take up heat from the heat receiving surface, when the heat receiving surface is heated. The heat taken up by the heat storage body may be provided to the heating space over time to heat the aerosol-generating article provided therein. The heat storage body may take up a certain amount of heat over a first time and release the amount of heat over a second, greater time. For example, the second time may be at least twenty times the first time, or at least fifteen times the first time, or at least ten times the first time, or at least five times the first time, or at least double the first time. Due to the buffer function of the heat storage body, overheating of the heating space may be prevented, when the heat receiving surface is heated to high temperatures. Further, the heat storage body may allow the heating space to maintain an aerosol generation temperature for a longer period of time after heating of the heat receiving surface has stopped.

The inner heat conduction body may facilitate transferring heat stored in the heat storage body towards the heating space, and thus towards an aerosol-generating article at least partially received in the heating space. The inner heat conduction body may distribute the heat to desired regions at the aerosol-generating article in an efficient manner. The inner heat conduction body may guide a flow of heat from the heat storage body.

The material of the heat storage body may have a specific heat capacity between 300 joule per kelvin per kilogram and 1500 joule per kelvin per kilogram, or between 500 joule per kelvin per kilogram and 1200 joule per kelvin per kilogram, or between 600 joule per kelvin per kilogram and 1000 joule per kelvin per kilogram, or between 600 joule per kelvin per kilogram and 800 joule per kelvin per kilogram.

The material of the heat storage body may, for example, be glass or metal. The material of the heat storage body may comprise glass or metal.

One or both of the material of the heat storage body and the material of the inner heat conduction body may have a melting temperature above 800 degrees Celsius, or above 900 degrees Celsius, or above 1000 degrees Celsius, or above 1100 degrees Celsius, or above 1300 degrees Celsius, or above 1500 degrees Celsius. In view of such melting temperatures, the heat storage body and the inner heat conduction body may be prevented from melting upon heating the heat receiving surface. In particular, the heat storage body and the inner heat conduction body may be prevented from melting, when the heat receiving surface is heated by one or more flames, such as a flame generated by a common cigarette lighter.

One or both of the heat storage body and the inner heat conduction body may circumferentially surround the heating space. If the heat storage body circumferentially surrounds the heating space, the heat storage body may store heat circumferentially around the heating space. If the inner heat conduction body circumferentially surrounds the heating space, heat may be distributed by the inner heat conduction body fully around the heating space. One or both of the heat storage body and the inner heat conduction body may surround the heating space over a full circumference of the heating space. One or more of the heat storage body and the inner heat conduction body may surround the heating space over at least 50 percent, or at least 60 percent, or at least 70 percent, or at least 80 percent, or at least 90 percent of a full circumference of the heating space. One or more of the heat storage body and the inner heat conduction body may surround the heating space over no more than 90 percent, or no more than 80 percent, or no more than 70 percent, or no more than 60 percent, or no more than 50 percent of a full circumference of the heating space.

The inner heat conduction body may comprise a protrusion extending into the heating space. The protrusion may be configured to immerse into the aerosol-generating article upon insertion of the aerosol-generating article into the heating space. In particular, the protrusion may be configured to immerse into an aerosol-generating section of the aerosol-generating article. The protrusion may conduct heat into the aerosol-generating article to heat the aerosol-generating article from the inside. The protrusion may facilitate homogenous heating of the aerosol-generating article. The protrusion may have the form of a pin or a blade, for example. The protrusion may be an integral part of the inner heat conduction body. The protrusion may extend into the heating space along the axial direction. The protrusion may have a length into the axial direction between 5 and 50 millimeters, or between 5 and 40 millimeters, or between 5 and 30 millimeters, or between 5 and 25 millimeters, or between 5 and 20 millimeters, or between 5 and 15 millimeters, or between 5 and 10 millimeters, or between 2 and 5 millimeters, or between 10 and 15 millimeters, or between 10 and 20 millimeters.

The inner heat conduction body may form at least a part of a wall defining the heating space. A surface of the inner heat conduction body may at least partially delimit the heating space. If there are no elements of the aerosol-generating device between the inner heat conduction body and the aerosol-generating article received within the heating space, the inner heat conduction body may efficiently provide heat to the heating space.

The inner heat conduction body may be in contact with the heat storage body. Contact between the inner heat conduction body and the heat storage body may facilitate efficient heat transfer between the heat storage body and the inner heat conduction body. The inner heat conduction body may be in contact with the heat storage body circumferentially around the heating space.

The aerosol-generating device may comprise an outer heat conduction body. The outer heat conduction body may be provided between the heat receiving surface and the heat storage body. The outer heat conduction body may facilitate transfer of heat from the heat receiving surface to the heat storage body.

A material of the outer heat conduction body may have a higher thermal conductivity than the material of the heat storage body.

The material of the heat storage body may have a higher specific heat capacity than the material of the outer heat conduction body.

The outer heat conduction body may be formed of the same material as the inner heat conduction body.

The specific heat capacity of the material of the heat storage body may be at least 300 percent, or at least 250 percent, or at least 200 percent, or at least 150 percent, or at least 130 percent, or at least 110 percent of at least one of the specific heat capacity of the material of the inner heat conduction body and the specific heat capacity of the material of the outer heat conduction body.

At least one of the thermal conductivity of the material of the inner heat conduction body and the thermal conductivity of the material of the outer heat conduction body may be at least 500 times, or at least 400 times, or at least 300 times, or at least 200 times, or at least 100 times, or at least 50 times, or at least 30 times, or at least 10 times, or at least 5 times the thermal conductivity of the material of the heat storage body. At least one of the thermal conductivity of the material of the inner heat conduction body and the thermal conductivity of the material of the outer heat conduction body may be at least 200 percent, or at least 150 percent, or at least 130 percent, or at least 110 percent of the thermal conductivity of the material of the heat storage body.

The outer heat conduction body may be in contact with the heat storage body to facilitate heat transfer between the outer heat conduction body and the heat storage body.

The heat receiving surface may be a surface of the outer heat conduction body. The heat receiving surface may be an outer surface of the outer heat conduction body with respect to the heating space. The heat receiving surface may be a radially outer surface of the outer heat conduction body. The heat receiving surface may be a surface of the outer heat conduction body that is spaced from the heating space with respect to the axial direction.

The outer heat conduction body may circumferentially surround the heating space. The outer heat conduction body may circumferentially surround the heat storage body. The outer heat conduction body may at least partially be provided radially outwards of the heat storage body. The outer heat conduction body may at least partially be provided at a side of the heat storage body that axially faces away from the heating space.

A thermal resistance for heat transport through the outer heat conduction body in a radial direction may be different at at least two different locations of the outer heat conduction body. For example, the thermal resistance for heat transport through the outer heat conduction body at a first location of the outer heat conduction body may be at least 300 percent, or at least 250 percent, or at least 200 percent, or at least 150 percent, or at least 130 percent, or at least 110 percent of the thermal resistance for heat transport through the outer heat conduction body at a second location of the outer heat conduction body. The thermal resistance for heat transport through the outer heat conduction body in a radial direction may vary along at least one of the axial direction and a circumferential direction. A non-homogenous thermal resistance for heat transport through the outer heat conduction body in a radial direction may allow directed heat transport through the outer heat conduction body.

A thickness of the outer heat conduction body may be different at at least two different locations of the outer heat conduction body. For example, the thickness of the outer heat conduction body at a first location of the outer heat conduction body may be at least 300 percent, or at least 250 percent, or at least 200 percent, or at least 150 percent, or at least 130 percent, or at least 110 percent of the thickness of the outer heat conduction body at a second location of the outer heat conduction body. A varying thickness of the outer heat conduction body may lead to different thermal resistances for heat transport through the outer heat conduction body in a radial direction. The thickness of the outer heat conduction body may vary along at least one of the axial direction and a circumferential direction. A thickness of the outer heat conduction body may be highest at the heat receiving surface. A thickness of the outer heat conduction body may decrease with the distance to the heat receiving surface along at least one of the axial direction and the circumferential direction.

One or more channels may be provided in the outer heat conduction body. The one or more channels may influence thermal resistance for heat transport through the outer heat conduction body. Heated air may flow through the one or more channels. The one or more channels may comprise one or more openings. The one or more openings may be provided at the heat receiving surface.

A thermal resistance for heat transport through the outer heat conduction body along a radial direction may be highest at the heat receiving surface. This may prevent excessive heating of the heating chamber and the aerosol-generating article provided in the heating chamber at a position that corresponds to the position of the heat receiving surface. A high thermal resistance for heat transport through the outer heat conduction body along the radial direction at the receiving surface may cause heat from the heat receiving surface to be more evenly distributed over the heating space. The thermal resistance for heat transport through the outer heat conduction body along the radial direction may increase with the distance to heat receiving surface, in particular along at least one of the axial direction and the circumferential direction.

The outer heat conduction body may comprise two or more different materials having different thermal conductivities. The two or more different materials may be arranged to provide a desired heat conduction profile. The two or more different materials may be arranged to provide a desired distribution of a thermal resistance for heat transport through the outer heat conduction body along a radial direction. The outer heat conduction body may, for example, comprise two or more layers, wherein each layer is formed of a different material. The layers may, for example, be arranged one behind the other with respect to the axial direction or with respect to a radial direction (or both the axial direction and the radial direction).

The aerosol-generating device may further comprise a heater configured to heat the heat receiving surface. The heater may, for example, comprise an electrical resistance heater, or an induction heater. The heater may be configured to generate one or more flames to heat the heat receiving surface. The heater may be configured to burn gas to generate the one or more flames. The one or more flames may comprise at least two flames. The heater may be formed integrally with a main body of the aerosol-generating device. Alternatively, the heater may be, fully or partially, provided as a separate entity. The heater may, for example, be a conventional cigarette lighter.

According to a further aspect of the present invention, there is provided an aerosol-generating system. The aerosol-generating system may comprise the aerosol-generating device and the aerosol-generating article. The aerosol-generating article may have an aerosol-generating section. The aerosol-generating section may comprise material configured to generate aerosol upon being heated. The aerosol-generating section may be at least partially received in the heating space when the aerosol-generating article is at least partially received in the heating space.

According to another aspect of the present invention, there is provided a method for generating aerosol. The method comprises heating a heat receiving surface of an aerosol-generating device. The aerosol-generating device at least partially receives an aerosol-generating article. Heat from heating the heat receiving surface is stored in a heat storage body provided between the heat receiving surface and the aerosol-generating article. Heat is distributed to the aerosol-generating article via an inner heat conduction body provided between the heat storage body and the aerosol-generating article. A material of the heat storage body has a higher specific heat capacity than a material of the inner heat conduction body.

The material of the inner heat conduction body may have a higher thermal conductivity than the material of the heat storage body.

The heat receiving surface may be heated with more than one flame at the same time. For example, the heat receiving surface may be heated with two or more than two flames at the same time. Heating the heat receiving surface with more than one flame at the same time allows using smaller flames to convey a specific amount of heat to the heat receiving surface as compared to using only one flame. Further, using more than one flame at the same time allows spatially distributing the heat in an efficient manner.

The aerosol-generating article may extend along an axial direction when the aerosol-generating article is at least partially received in the aerosol-generating device. The axial direction may correspond to a direction along which the aerosol-generating article is inserted into the aerosol-generating device.

At least two of the flames may be generated at different circumferential positions around the axial direction. Heat may thus be supplied from different circumferential angles around the axial direction.

At least two of the flames may be spaced along a direction parallel to the axial direction. Heat may thus be supplied at different positions along the axial direction.

According to another aspect of the present invention, there is provided a method for generating aerosol. The method comprises heating a heat receiving surface of an aerosol-generating device. The aerosol-generating device at least partially receives an aerosol-generating article extending along an axial direction. The heat receiving surface is heated with more than one flame at the same time.

At least two of the flames may be generated at different circumferential positions around the axial direction.

At least two of the flames may be spaced along a direction parallel to the axial direction.

According to a further aspect of the present invention, there is provided a use of an axially extending tube that circumferentially surrounds an aerosol-generating substance to achieve substantially homogeneous heating of the aerosol-generating substance, wherein a thermal resistance for heat transport through the tube along a radial direction varies along at least one of the axial direction and a circumference of the tube.

For example, the thermal resistance for heat transport through the tube along a radial direction may vary along at least one of the axial direction and a circumference of the tube by at least 200 percent, or by at least 150 percent, or by at least 100 percent, or by at least 70 percent, or by at least 50 percent, or by at least 30 percent, or by at least 20 percent, or by at least 10 percent of a minimum value of the thermal resistance for heat transport through the tube along a radial direction.

The thermal resistance for heat transport through the tube along a radial direction may change along at least one of the axial direction and the circumference of the tube in a way that influences heat transport towards the aerosol-generating substance to be substantially homogeneous. For example, a thermal resistance for heat transport through the tube along a radial direction may be highest at a location that is nearest to a heat source. The thermal resistance may decrease from that location along at least one of the axial direction and the circumference of the tube.

Substantially homogenous heating of the aerosol-generating substance may be achieved if during heating, a temperature difference of two portions of the aerosol-generating substance is not higher than 100 degrees Celsius, or not higher than 75 degrees Celsius, or not higher than 50 degrees Celsius, or not higher than 25 degrees Celsius, or not higher than 10 degrees Celsius.

According to another aspect of the present invention, there is provided an aerosol-generating device comprising an axially extending heating chamber configured to at least partially receive an aerosol-generating article. The aerosol-generating device further comprises a heater actuation mechanism configured to move between an engaging configuration and a non-engaging configuration. The heater actuation mechanism is configured to act on a heater in the engaging configuration to operate the heater to generate heat. The heater actuation mechanism is configured to not act on the heater in the non-engaging configuration to stop generation of the heat by the heater. The heater actuation mechanism comprises an operating element. The operating element is configured to be moved to move the heater actuation mechanism from the non-engaging configuration into the engaging configuration. The aerosol-generating device further comprises a blocking mechanism. The blocking mechanism is configured to temporarily block a movement of the heater actuation mechanism from the engaging configuration into the non-engaging configuration or from the non-engaging configuration into the engaging configuration.

The heater actuation mechanism allows operating the heater by moving the operating element.

If the blocking mechanism is configured to temporarily block the movement of the heater actuation mechanism from the engaging configuration into the non-engaging configuration, the blocking mechanism may delay movement of the heater actuation mechanism from the engaging configuration into the non-engaging configuration. The stopping of heat generation may be delayed due to the movement of the heater actuation mechanism into the non-engaging configuration being delayed. This may ensure that sufficient heat is generated by the heater before heat generation is stopped.

If the blocking mechanism is configured to temporarily block the movement of the heater actuation mechanism from the non-engaging configuration into the engaging configuration, generation of heat by the heater may be delayed. This may, for example, be useful to prevent excessive heat generation which might lead to overheating of the heating chamber or the aerosol-generating article. By delaying generation of heat by the heater, an increase in temperature that might lead to combustion of the aerosol-generating article may be prevented.

The blocking mechanism may influence the heating time (the time in which the heater generates heat). Control of the heating time by the blocking mechanism may ensure that the aerosol-generating article is heated according to predefined specifications or according to a defined temperature profile.

Movement of the operating element to move the heater actuation mechanism from the non-engaging configuration into the engaging configuration may be effected by a user. The operating element may be configured to be moved by the user to move the heater actuation mechanism from the non-engaging configuration into the engaging configuration. The operating element may be configured to be engaged by the user to be moved. The operating element may be configured to be moved by drive means, such as a motor or a spring. The drive means may be configured to be actuated by a user to move the operating element.

The blocking mechanism may be configured to automatically release movement of the heater actuation means subsequently to temporarily blocking the movement of the heater actuation mechanism. The blocking mechanism may be configured to temporarily block the movement of the heater actuation mechanism for a blocking time. The blocking time may be a predetermined time. The blocking time may be predetermined by the configuration of the blocking mechanism. The blocking time may be determined by one or more operational parameters of the aerosol-generating device, such as a temperature or a mode of operation.

The heater actuation mechanism may comprise a restoration element providing a mechanical force configured to move the heater actuation mechanism towards the non-engaging configuration. After moving the operating element to move the heater actuation mechanism from the non-engaging configuration into the engaging configuration, a user may release the operating element. The heater actuation means may automatically return to the non-engaging configuration due to the restoration element. However, the heater actuation mechanism may not immediately return to the non-engaging configuration, but with a delay caused by the blocking mechanism. The delay by the blocking mechanism may define an operation time of the heater after the operation element has been released by the user.

The engaging configuration may comprise a plurality of engaging sub-configurations of the heater actuation mechanism. The operating element may allow a user to selectively bring the heater actuation mechanism into any one of the engaging sub-configurations. The plurality of engaging sub-configurations may give the user a means to actuate the heater to different degrees.

The blocking mechanism may be configured to delay return of the heater actuation mechanism from the respective engaging sub-configuration into the non-engaging configuration by different times for the different engaging sub-configurations. Thus, depending on the engaging sub-configuration into which the user brings the heater actuation mechanism, the heater may continue to operate to generate heat for different periods of time.

The blocking mechanism may comprise a movable part. The movable part may be configured to move between a release position and a blocking position. In the release position, the movable part may allow movement of the heat actuation mechanism towards at least one of the non-engaging configuration and the engaging configuration. In the blocking position, the movable part may block movement of the heater actuation mechanism towards the at least one of the non-engaging configuration and the engaging configuration. In particular, the blocking mechanism may, in the release position, allow movement of the heater actuation mechanism towards the non-engaging configuration and, in the blocking position, block movement of the heater actuation mechanism towards the non-engaging configuration. Alternatively, or additionally, the movable part may, in the release position, allow movement of the heater actuation mechanism towards the engaging configuration and, in the blocking position, block movement of the heater actuation mechanism towards the engaging configuration.

The movable part may move between the release position and the blocking position automatically. The movable part may be configured to be moved by a user between the release position and the blocking position.

The movable part may be configured to move between the release position and the blocking position depending on a temperature. This may allow the movable part to delay operation of the heater, or stopping of the operation of the heater, depending on the temperature. If the movable part is configured to move between the release position and the blocking position depending on a temperature, a feedback control of the temperature via the heater may be implemented.

The temperature depending on which the movable part moves between the release position and the blocking position may be, for example, a temperature of a part of the aerosol-generating device, or a temperature inside the heating chamber, or a temperature of a wall of the heating chamber, or a temperature of the aerosol-generating article.

The blocking mechanism may comprise a thermal expansion element. The thermal expansion element may be configured to move the movable part between the release position and the blocking position depending on a temperature of the thermal expansion element.

The moveable part may be configured to periodically move between the release position and the blocking position to delay the movement of the heater actuation mechanism into the non-engaging configuration or into the engaging configuration. Periodic movement between the release position and the blocking position may delay the movement of the heater actuation mechanism by periodically releasing and blocking the movement of the heater actuation mechanism.

The heater actuation mechanism and the blocking mechanism may together form a ratchet mechanism. The ratchet mechanism may be configured to allow movement of the heater actuation mechanism in one direction and selectively block movement of the heater actuation mechanism in the opposing direction. For example, the ratchet mechanism may allow movement of the heater actuation mechanism into the engaging configuration and block movement of the heater actuation mechanism into the non-engaging configuration, if the movable part is in the blocking position. Alternatively, the ratchet mechanism may allow movement of the heater actuation mechanism into the non-engaging configuration and block movement of the heater actuation mechanism into the engaging configuration, if the movable part is in the blocking position.

The heater actuation mechanism may comprise a sliding element configured to be slid via the operating element. The sliding element may, for example, be configured to be slid in a body of the aerosol-generating device. The sliding element may be connected to the operating element.

The heater actuation mechanism may comprise an engagement element configured to act on the heater in the engaging configuration of the heater actuation mechanism. The engagement element may be slidably guided on the sliding element. When the engagement element is slidably guided on the sliding element, the engagement element does not directly follow every movement of the operating element. This may generate a delay between movement of the operating element and actuation of the heater by the engagement element.

The heater actuation mechanism may comprise a spring element configured to bias the engagement element towards the heater. The spring element may ensure that the engagement element acts on the heater within a range of configurations of the heater actuation mechanism (range of non-engaging configurations).

The sliding element may comprise a plurality of teeth. The blocking element may comprise one or more blocking parts configured to engage with the teeth. By engaging with the teeth of the sliding element, the blocking part may allow or block movement of the heater actuation mechanism. The one or more blocking parts may be one or more movable parts.

According to another aspect of the present invention, there is provided an aerosol-generating system. The aerosol-generating system may comprise the aerosol-generating device and the heater. The heater may be configured to generate heat when acted upon by the heater actuation mechanism. The heater may be configured to not generate heat when not acted upon by the heater actuation mechanism.

Bringing the heater actuation mechanism into the engaging configuration to operate the heater may be the only action required to start generation of heat by the heater. Alternatively, a further action may be required to start generation of heat by the heater. The heater may require two or more actions to start generating heat. One or more of those actions may be carried out by the heater actuation mechanism, when the heater actuation mechanism is brought into the engaging configuration. One or more additional action may be carried out independently of the heater actuation mechanism.

Bringing the heater actuation mechanism from the engaging configuration into the non-engaging configuration may be required to stop generation of the heat by the heater. There may be, but does not have to be, one or more additional ways of stopping generation of the heat by the heater.

The heater may comprise a gas tank. The gas tank may be configured to release gas when the heater is acted upon by the heater actuation mechanism. The gas tank may be configured to prevent the release of gas when the heater is not acted upon by the heater actuation mechanism.

The gas tank may be releasably coupled to a body of the aerosol-generating device.

The aerosol-generating system may further comprise an ignition mechanism configured to ignite the gas. The ignition mechanism may be operated independently of the heater actuation mechanism.

The gas tank and the ignition mechanism, or both, may be an integral part of the aerosol-generating device. The gas tank or the ignition mechanism, or both, may be separate from the aerosol-generating device.

In particular, the gas tank and the ignition mechanism may be part of a separate heater. The heater may be a lighter. The heater may, for example, be a conventional cigarette lighter.

The heater may be coupled to the aerosol-generating device.

According to another aspect of the present invention, there is provided a method for generating aerosol. An operating element is moved along a path in an activation direction, thereby acting on a heater via a heater actuation mechanism. The heater generates heat in response to being acted upon by the heater actuation mechanism. The operating element is returned in a motion along the path against the activation direction. One or more moving parts of a blocking mechanism move to delay return of the operating element. The heater ceases to generate heat in response to no longer being acted upon by the heater actuation mechanism.

In response to the operating element being moved in the activation direction, a restoration element builds up a restoration force against the movement of the operating element. The restoration force may bias the operating element in a direction against the activation direction, thus causing the operating element to return along the path against the activation direction.

Gas may be released from a gas tank in response to the heater being acted upon by the heater actuation mechanism. The gas may sustain a flame heating a heat receiving surface of an aerosol-generating device. The aerosol-generating device may at least partially receive an aerosol-generating article.

According to another aspect of the present invention, there is provided a use of a change in length of a thermal expansion element caused by a temperature change to extinguish a flame after the flame has heated an aerosol-generating device at least partially receiving an aerosol-generating article.

The thermal expansion element allows extinguishing the flame in a temperature-dependent manner. A feedback control scheme may be implemented to control a temperature.

The aerosol-generating article referred to herein may be at least essentially rod-shaped. The aerosol-generating article may extend in parallel to the axial direction, when at least partially inserted into the aerosol-generating device.

The aerosol-generating article may comprise an aerosol-generating section. The aerosol-generating section may comprise aerosol-generating material. The aerosol-generating material may be configured to release aerosol upon being heated. The aerosol-generating material may, for example, comprise herbaceous material. The aerosol-generating material may, for example, comprise tobacco material.

The aerosol-generating article may comprise a filter section. When the aerosol-generating article is inserted into the aerosol-generating device, the filter section may at least partially protrude from the aerosol-generating device to be accessible to a user.

According to a further aspect of the present invention there is provided an aerosol-generating system comprising an aerosol-generating device according to any one of the embodiments, aspects, or examples described herein. The aerosol-generating system also comprises the aerosol-generating article. The aerosol-generating article may comprise an aerosol-forming substrate which may be the aerosol-generating material. As used herein, the term “aerosol-generating article” refers to an article comprising an aerosol-forming substrate that, when heated, releases volatile compounds that can form an aerosol.

The aerosol-forming substrate may comprise a plug of tobacco. The tobacco plug may comprise one or more of: powder, granules, pellets, shreds, spaghettis, strips or sheets containing one or more of: tobacco leaf, fragments of tobacco ribs, reconstituted tobacco, homogenised tobacco, extruded tobacco and expanded tobacco. Optionally, the tobacco plug may contain additional tobacco or non-tobacco volatile flavour compounds, to be released upon heating of the tobacco plug. Optionally, the tobacco plug may also contain capsules that, for example, include the additional tobacco or non-tobacco volatile flavour compounds. Such capsules may melt during heating of the tobacco plug. Alternatively, or in addition, such capsules may be crushed prior to, during, or after heating of the tobacco plug.

Where the tobacco plug comprises homogenised tobacco material, the homogenised tobacco material may be formed by agglomerating particulate tobacco. The homogenised tobacco material may be in the form of a sheet. The homogenised tobacco material may have an aerosol-former content of greater than 5 percent on a dry weight basis. The homogenised tobacco material may alternatively have an aerosol former content of between 5 percent and 30 percent by weight on a dry weight basis. Sheets of homogenised tobacco material may be formed by agglomerating particulate tobacco obtained by grinding or otherwise comminuting one or both of tobacco leaf lamina and tobacco leaf stems; alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco. Alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof. Sheets of homogenised tobacco material are preferably formed by a casting process of the type generally comprising casting a slurry comprising particulate tobacco and one or more binders onto a conveyor belt or other support surface, drying the cast slurry to form a sheet of homogenised tobacco material and removing the sheet of homogenised tobacco material from the support surface.

The aerosol-generating article may have a total length of between approximately 30 millimetres and approximately 100 millimetres. The aerosol-generating article may have an external diameter of between approximately 5 millimetres and approximately 13 millimetres.

The aerosol-generating article may comprise a mouthpiece positioned downstream of the tobacco plug. The mouthpiece may be located at a downstream end of the aerosol-generating article. The mouthpiece may be a cellulose acetate filter plug. Preferably, the mouthpiece is approximately 7 millimetres in length, but can have a length of between approximately 5 millimetres to approximately 10 millimetres.

The tobacco plug may have a length of approximately 10 millimetres. The tobacco plug may have a length of approximately 12 millimetres.

The diameter of the tobacco plug may be between approximately 5 millimetres and approximately 12 millimetres.

In a preferred embodiment, the aerosol-generating article has a total length of between approximately 40 millimetres and approximately 50 millimetres. Preferably, the aerosol-generating article has a total length of approximately 45 millimetres. Preferably, the aerosol-generating article has an external diameter of approximately 7.2 millimetres.

The present disclosure comprise various aspects, embodiments, and examples. Features, advantages, and explanations disclosed with reference to any one of those aspects, embodiments, and examples may be combined with, or transferred to, any one of the remaining aspects, embodiments, and examples. The aerosol-generating devices or systems described herein may be suitable, adapted and configured to carry out the methods for generating aerosol described herein.

Where the present disclosure refers to a material of an item having a certain specific heat capacity and the item is comprised of different individual materials (for example different material layers), the specific heat capacity of the material of the item is to be understood as corresponding to a weighted average of the specific heat capacities of the individual materials of which the item is comprised. The weighting is understood to be carried out according to the mass percentages of the individual materials of which the item is comprised.

Where the present disclosure refers to a material of an item having a certain thermal conductivity and the item is comprised of different individual materials (for example different material layers), the thermal conductivity of the material of the item is to be understood as corresponding to a weighted average of the thermal conductivities of the individual materials of which the item is comprised. The weighting is understood to be carried out according to the mass percentages of the individual materials of which the item is comprised.

The expression “rod-shaped” as used herein includes, but is not limited to, rod-shapes with a circular cross-section. “Rod-shaped” as used herein may also include rod-shapes with other cross-sections, such as, for example, a rectangular cross-section, or an elliptic cross-section, or a triangular cross-section, or an irregular cross-section, or any other cross-section. The expression “rod-shaped” may include cylindrical shapes, whereby the base surface of the cylinder may be a circular surface or a surface of any other shape, such as a rectangular surface, or an elliptic surface, or a triangular surface, or an irregular surface, or any other surface.

When a first item immerses into a second item, the first item may at least partially enter a volume of the second item. After immersing into the second item, at least a part of the first item may be surrounded by the second item. For example, a first item may immerse into a second item by being pushed into the second item.

The invention is defined in the claims. However, below there is provided a non-exhaustive list of non-limiting examples. Any one or more of the features of these examples may be combined with any one or more features of another example, embodiment, or aspect described herein.
Example Ex1: Aerosol-generating device comprising:
an axially extending heating space configured to at least partially receive an aerosol-generating article;
a heat receiving surface provided outside of the heating space;
a heat storage body provided between the heat receiving surface and the heating space; and
an inner heat conduction body provided between the heat storage body and the heating space;
wherein a material of the heat storage body has a higher specific heat capacity than a material of the inner heat conduction body; and
wherein the material of the inner heat conduction body has a higher thermal conductivity than the material of the heat storage body.
Example Ex2: Aerosol-generating device according to Example Ex1, wherein the material of the heat storage body has a specific heat capacity between 300 joule per kelvin per kilogram and 1500 joule per kelvin per kilogram, or between 500 joule per kelvin per kilogram and 1200 joule per kelvin per kilogram, or between 600 joule per kelvin per kilogram and 1000 joule per kelvin per kilogram, or between 600 joule per kelvin per kilogram and 800 joule per kelvin per kilogram.
Example Ex3: Aerosol-generating device according to Example Ex1 or Ex2, wherein one or both of the material of the heat storage body and the material of the inner heat conduction body has a melting temperature above 800 degrees Celsius, or above 900 degrees Celsius, or above 1000 degrees Celsius, or above 1100 degrees Celsius, or above 1300 degrees Celsius, or above 1500 degrees Celsius.
Example Ex4: Aerosol-generating device according to any one of Examples Ex1 to Ex3, wherein one or both of the heat storage body and the inner heat conduction body circumferentially surround the heating space.
Example Ex5: Aerosol-generating device according to any one of Examples Ex1 to Ex4, wherein the inner heat conduction body comprises a protrusion extending into the heating space and configured to immerse into the aerosol-generating article upon insertion of the aerosol-generating article into the heating space.
Example Ex6: Aerosol-generating device according to any one of Examples Ex1 to Ex5, wherein the inner heat conduction body forms at least a part of a wall defining the heating space.
Example Ex7: Aerosol-generating device according to any one of Examples Ex1 to Ex6, wherein the inner heat conduction body is in contact with the heat storage body.
Example Ex8: Aerosol-generating device according to any one of Examples Ex1 to Ex7, further comprising an outer heat conduction body provided between the heat receiving surface and the heat storage body.
Example Ex9: Aerosol-generating device according to Example Ex8, wherein a material of the outer heat conduction body has a higher thermal conductivity than the material of the heat storage body.
Example Ex10: Aerosol-generating device according to Example Ex8 or Ex9, wherein the material of the heat storage body has a higher specific heat capacity than the material of the outer heat conduction body.
Example Ex11: Aerosol-generating device according to any one of Examples Ex8 to Ex10, wherein a thermal resistance for heat transport through the outer heat conduction body in a radial direction is different at at least two different locations of the outer heat conduction body.
Example Ex12: Aerosol-generating device according to any one of Examples Ex8 to Ex11, wherein a thickness of the outer heat conduction body is different at at least two different locations of the outer heat conduction body.
Example Ex13: Aerosol-generating device according to any one of Examples Ex8 to Ex12, wherein one or more channels are provided in the outer heat conduction body.
Example Ex14: Aerosol-generating device according to any one of Examples Ex8 to Ex13, wherein a thermal resistance for heat transport through the outer heat conduction body along a radial direction is highest at the heat receiving surface.
Example Ex15: Aerosol-generating device according to any one of Examples Ex8 to Ex14, wherein the outer heat conduction body comprises at least two different materials having different thermal conductivities.
Example Ex16: Aerosol-generating device according to any one of Examples Ex1 to Ex15, further comprising a heater configured to generate one or more flames to heat the heat receiving surface.
Example Ex17: Aerosol-generating system, comprising:
the aerosol-generating device according to any one of the preceding claims; and the aerosol-generating article;
wherein the aerosol-generating article has an aerosol-generating section comprising material configured to generate aerosol upon being heated;
wherein the aerosol-generating section is at least partially received in the heating space when the aerosol-generating article is at least partially received in the heating space.
Example Ex18: Aerosol-generating system according to Example Ex17, wherein the aerosol-generating article comprises a mouthpiece configured to protrude from the aerosol-generating device when the aerosol-generating article is at least partially received in the heating space.
Example Ex19: Aerosol-generating system according to Example Ex17 or Ex18, further comprising a heater configured to heat the heat receiving surface.
Example Ex20: Method for generating aerosol, comprising:
heating a heat receiving surface of an aerosol-generating device;
wherein the aerosol-generating device at least partially receives an aerosol-generating article; and
storing heat from heating the heat receiving surface in a heat storage body provided between the heat receiving surface and the aerosol-generating article; and
distributing heat to the aerosol-generating article via an inner heat conduction body provided between the heat storage body and the aerosol-generating article,
wherein a material of the heat storage body has a higher specific heat capacity than a material of the inner heat conduction body.
Example Ex21: Method according to Example Ex20, wherein the heat receiving surface is heated with more than one flame at the same time.
Example Ex22: Method according to Example Ex21, wherein the aerosol-generating article extends along an axial direction when the aerosol-generating article is at least partially received in the aerosol-generating device, and wherein at least two of the flames are generated at different circumferential positions around the axial direction.
Example Ex23: Method according to Example Ex21, wherein the aerosol-generating article extends along an axial direction when the aerosol-generating article is at least partially received in the aerosol-generating device, and wherein at least two of the flames are spaced along a direction parallel to the axial direction.
Example Ex24: Method for generating aerosol, comprising:
heating a heat receiving surface of an aerosol-generating device;
wherein the aerosol-generating device at least partially receives an aerosol-generating article extending along an axial direction; and
wherein the heat receiving surface is heated with more than one flame at the same time.
Example Ex25: Method according to Example Ex24, wherein at least two of the flames are generated at different circumferential positions around the axial direction.
Example Ex26: Method according to Example Ex24 or Ex25, wherein at least two of the flames are spaced along a direction parallel to the axial direction.
Example Ex27: Method according to any one of Examples Ex20 to Ex26, wherein the aerosol-generating device is the aerosol-generating device of any one of Examples Ex1 to Ex16 or of the aerosol-generating system of any one of Examples Ex17 to Ex19.
Example Ex28: Use of an axially extending tube that circumferentially surrounds an aerosol-generating substance to achieve substantially homogeneous heating of the aerosol-generating substance, wherein a thermal resistance for heat transport through the tube along a radial direction varies along at least one of the axial direction and a circumference of the tube.
Example Ex29: Aerosol-generating device comprising:
an axially extending heating chamber configured to at least partially receive an aerosol-generating article; and
a heater actuation mechanism configured to move between an engaging configuration and a non-engaging configuration;
wherein the heater actuation mechanism is configured to act on a heater in the engaging configuration to operate the heater to generate heat;
wherein the heater actuation mechanism is configured to not act on the heater in the non-engaging configuration to stop generation of the heat by the heater;
wherein the heater actuation mechanism comprises an operating element configured to be moved to move the heater actuation mechanism from the non-engaging configuration into the engaging configuration; and
wherein the aerosol-generating device further comprises a blocking mechanism configured to temporarily block a movement of the heater actuation mechanism from the engaging configuration into the non-engaging configuration or from the non-engaging configuration into the engaging configuration.
Example Ex30: Aerosol-generating device according to Example Ex29, wherein the blocking mechanism is configured to temporarily block the movement of the heater actuation mechanism from the engaging configuration into the non-engaging configuration, thereby delaying movement of the heater actuation mechanism from the engaging configuration into the non-engaging configuration.
Example Ex31: Aerosol-generating device according to Example Ex29 or Ex30, wherein the heater actuation mechanism comprises a restoration element providing a mechanical force configured to move the heater actuation mechanism towards the non-engaging configuration.
Example Ex32: Aerosol-generating device according to any one of Examples Ex29 to Ex31, wherein the engaging configuration comprises a plurality of engaging sub-configurations of the heater actuation mechanism and the operating element allows a user to selectively bring the heater actuation mechanism into any one of the engaging sub-configurations.
Example Ex33: Aerosol-generating device according to Example Ex32, wherein the blocking mechanism is configured to delay return of the heater actuation mechanism from the respective engaging sub-configuration into the non-engaging configuration by different times for the different engaging sub-configurations.
Example Ex34: Aerosol-generating device according to any one of Examples Ex29 to Ex33, wherein the blocking mechanism comprises a movable part configured to move between a release position, in which it allows movement of the heater actuation mechanism towards at least one of the non-engaging configuration and the engaging configuration, and a blocking position, in which is blocks movement of the heater actuation mechanism towards the at least one of the non-engaging configuration and the engaging configuration.
Example Ex35: Aerosol-generating device according to Example Ex34, wherein the movable part is configured to move between the release position and the blocking position depending on a temperature.
Example Ex36: Aerosol-generating device according to Example Ex35, wherein the temperature is a temperature of a part of the aerosol-generating device, or a temperature inside the heating chamber, or a temperature of a wall of the heating chamber, or a temperature inside the aerosol-generating article.
Example Ex37: Aerosol-generating device according to any one of Examples Ex34 to Ex36, wherein the blocking mechanism comprises a thermal expansion element configured to move the movable part between the release position and the blocking position depending on a temperature of the thermal expansion element.
Example Ex38: Aerosol-generating device according to Example Ex34, wherein the moveable part is configured to periodically move between the release positon and the blocking position to delay the movement of the heater actuation mechanism into the non-engaging configuration or into the engaging configuration.
Example Ex39: Aerosol-generating device according to any one of Examples Ex29 to Ex38, wherein the heater actuation mechanism and the blocking mechanism together form a ratchet mechanism.
Example Ex40: Aerosol-generating device according to any one of Examples Ex29 to Ex39, wherein the heater actuation mechanism comprises a sliding element configured to be slid via the operating element.
Example Ex41: Aerosol-generating article according to Example Ex40, wherein the heater actuation mechanism comprises an engagement element configured to act on the heater in the engaging configuration of the heater actuation mechanism, wherein the engagement element is slidably guided on the sliding element.
Example Ex42: Aerosol-generating article according to Example Ex41, wherein the heater actuation mechanism comprises a spring element configured to bias the engagement element towards the heater.
Example Ex43: Aerosol-generating device according to any one Examples Ex40 to Ex42, wherein the sliding element comprises a plurality of teeth and the blocking mechanism comprises one or more blocking parts configured to engage with the teeth.
Example Ex44: Aerosol-generating system comprising:
the aerosol-generating device according to any one of Examples Ex29 to Ex43; and
the heater, wherein the heater is configured to generate heat when acted upon by the heater actuation mechanism and to not generate heat when not acted upon by the heater actuation mechanism.
Example Ex45: Aerosol-generating system according to Example Ex44, wherein the heater comprises a gas tank configured to release gas when the heater is acted upon by the heater actuation mechanism and configured to prevent release of gas when the heater is not acted upon by the heater actuation mechanism.
Example Ex46: Aerosol-generating system according to Example Ex45, wherein the gas tank is releasably coupled to a body of the aerosol-generating device.
Example Ex47: Aerosol-generating system according Example Ex45 or Ex46, further comprising an ignition mechanism configured to ignite the gas.
Example Ex48: Method for generating aerosol, wherein
an operating element is moved along a path in an activation direction, thereby acting on a heater via a heater actuation mechanism;
the heater generates heat in response to being acted upon by the heater actuation mechanism;
the operating element is returned in a motion along the path against the activation direction;
one or more moving parts of a blocking mechanism move to delay return of the operating element; and
the heater ceases to generate heat in response to no longer being acted upon by the heater actuation mechanism.
Example Ex49: Method according to Example Ex48, wherein a restoration element builds up a restoration force against the movement of the operating element in response to the operating element being moved in the activation direction.
Example Ex50: Method according to Example Ex48 or Ex49, wherein gas is released from a gas tank in response to the heater being acted upon by the heater actuation mechanism, wherein the gas sustains a flame heating a heat receiving surface of an aerosol-generating device at least partially receiving an aerosol-generating article.
Example Ex51: Use of a change in length of a thermal expansion element caused by a temperature change to extinguish a flame after the flame has heated an aerosol-generating device at least partially receiving an aerosol-generating article.

Embodiments will now be further described with reference to the figures, in which:

FIG. 1 shows an aerosol-generating system according to an embodiment in which a heat receiving surface is provided radially outside of an axially extending heating space;

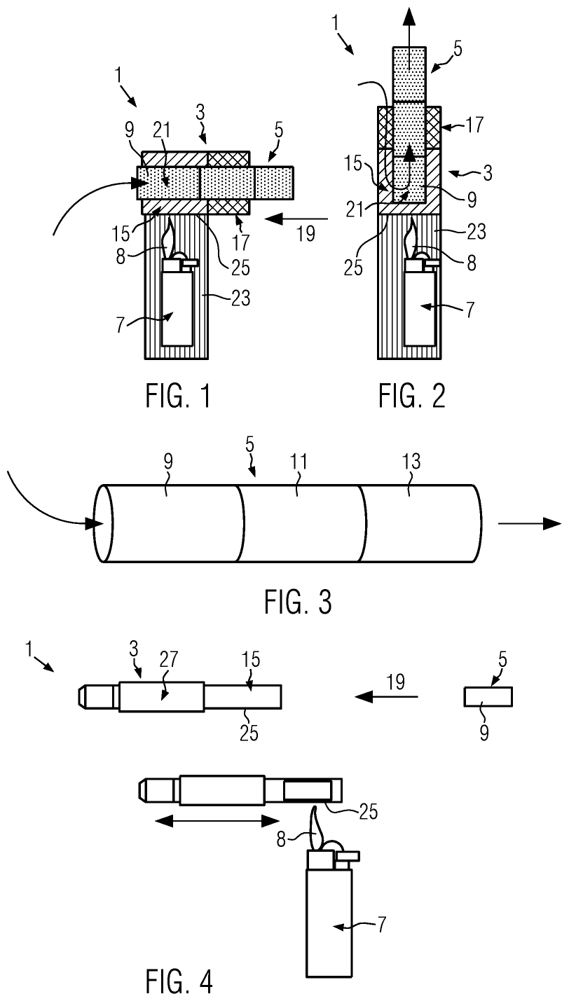

FIG. 2 shows an aerosol-generating system according to an embodiment in which a heat receiving surface is provided axially aligned with an axially extending heating space;

FIG. 3 shows an aerosol-generating article of an aerosol-generating system according to an embodiment;

FIG. 4 shows an aerosol-generating system according to an embodiment using a conventional cigarette lighter;

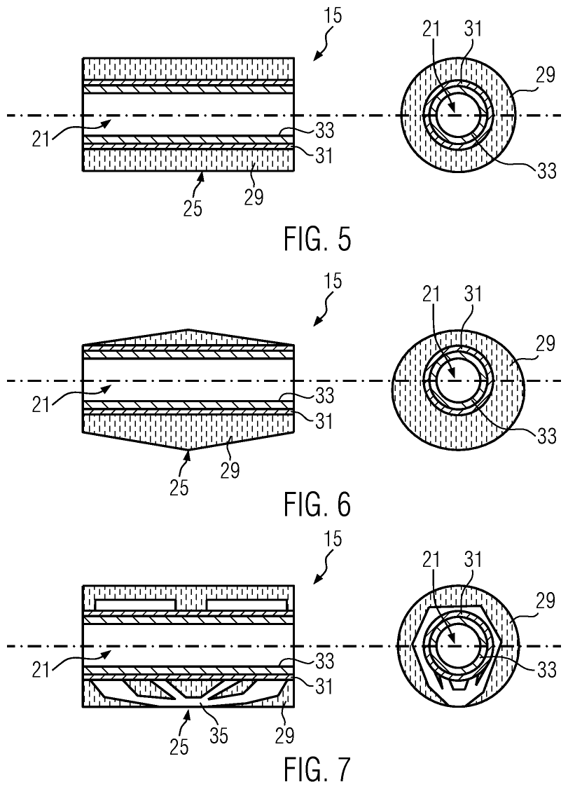

FIG. 5 shows schematic sectional views through a heating chamber according to an embodiment;

FIG. 6 shows schematic sectional views through a heating chamber according to another embodiment;

FIG. 7 shows schematic sectional views through a heating chamber according to a further embodiment;

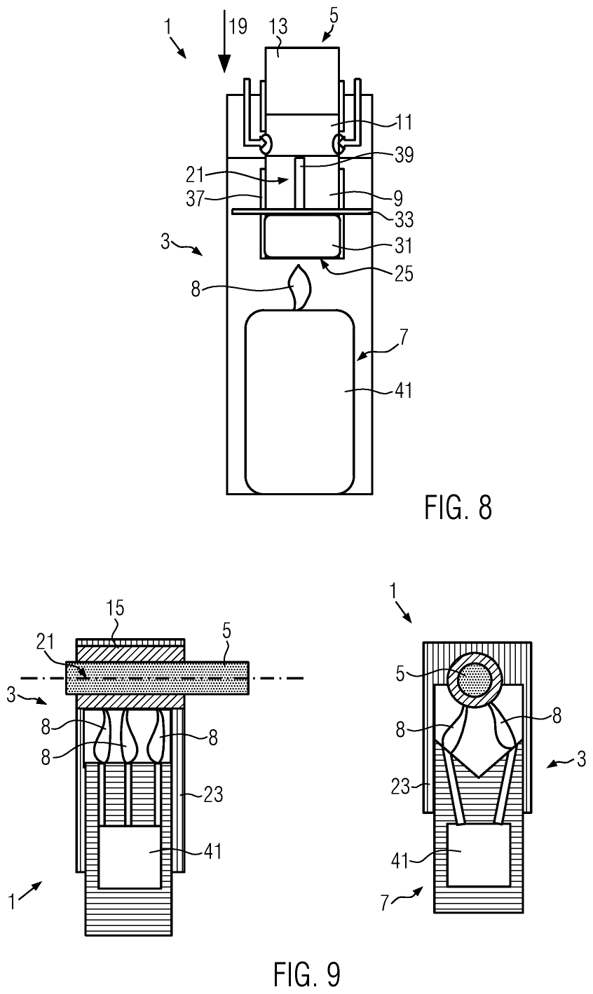

FIG. 8 shows a schematic sectional view of an aerosol-generating system according to an embodiment having a heat receiving surface axially aligned with an axially extending heating space;

FIG. 9 shows an embodiment of an aerosol-generating system having a heater generating multiple flames;

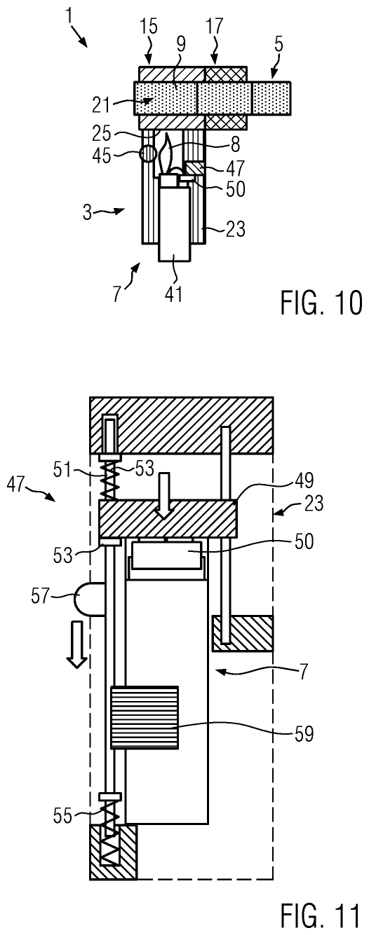

FIG. 10 shows an embodiment of an aerosol-generating system using a conventional cigarette lighter;

FIG. 11 shows a schematic sectional view illustrating a heater actuation mechanism of the system shown in FIG. 10;

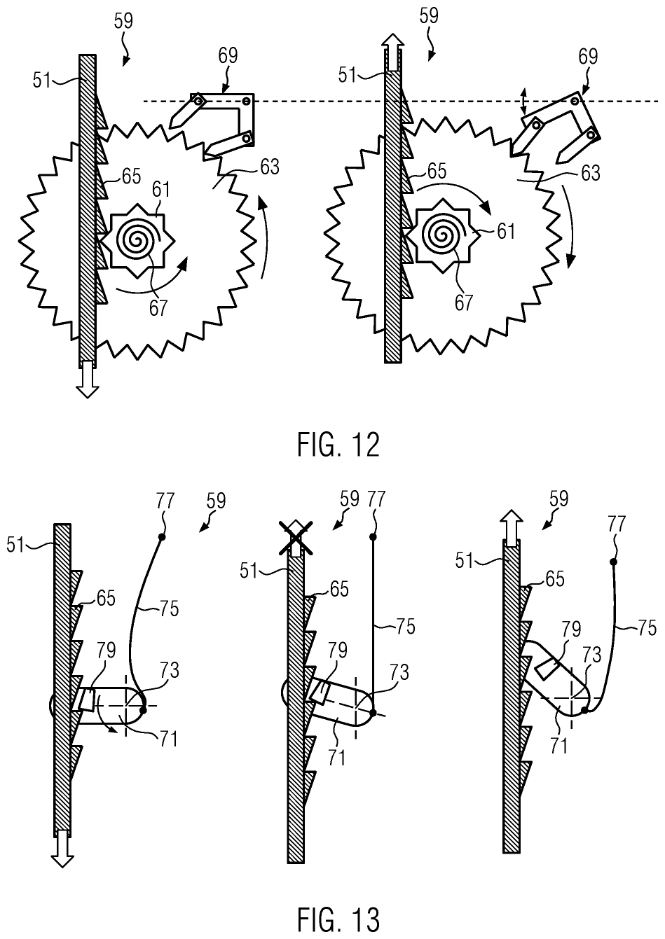

FIG. 12 illustrates a blocking mechanism that may be used in the aerosol-generating system of FIGS. 10 and 11 according to an embodiment; and

FIG. 13 shows another blocking mechanism that may be used in the aerosol-generating system of FIGS. 10 and 11 according to an embodiment.

FIG. 1 shows an aerosol-generating system 1 according to an embodiment. The aerosol-generating system 1 comprises an aerosol-generating device 3, an aerosol-generating article 5, and a heater 7.

FIG. 3 shows an exemplary embodiment of an aerosol-generating article 5 that may be used with the aerosol-generating device 3. The aerosol-generating article 5 comprises sections that are arranged one behind the other along an axial direction. The sections are connected to each other by one or more wrappers that may span one or more of the sections. The sections comprise an aerosol-generating section 9, a spacer section 11, and a filter section 13. The aerosol-generating section 9 comprises aerosol-generating material that is configured to generate aerosol-generating upon being heated. The aerosol-generating material may comprise herbaceous material, in particular tobacco material. The filter section 13 may comprise a filter through which aerosol passes before reaching the mouth of a user. The spacer section 11 may be arranged between the aerosol-generating section 9 and the filter section 13. Aerosol generated in the aerosol-generating section 9 may cool down while passing through the spacer section 11 to reduce a temperature of the aerosol before consumption.

As shown in FIG. 1, the aerosol-generating device 3 comprises an axially extending heating chamber 15 and a storage chamber 17 provided in coaxial arrangement with the heating chamber 15. The aerosol-generating article 5 may be inserted into the aerosol-generating device 3 in an insertion direction 19. In FIG. 1, the aerosol-generating article 5 is received in the aerosol-generating device 3 in a consumption position. In the consumption position, the aerosol-generating section 9 is received in a heating space 21 defined by the heating chamber 15.

In the embodiment of FIG. 1, the heater 7 is a conventional cigarette lighter. The aerosol-generating device 3 may comprise a heater receiving section 23 configured to receive the heater 7. Alternatively, the heater 7 may be an integral part of the aerosol-generating device 3, or the heater 7 may not be combined with or received in the aerosol-generating device 3, but may be a separate heater 7. Preferably, the heater 7 is configured to generate one or more flames 8.

The heater 7 is configured to heat a heat receiving surface 25 of the heating chamber 15. By heating the heat receiving surface 25, the heating space 21 within the heating chamber 15 is heated, thereby heating the aerosol-generating section 9 of the aerosol-generating article 3. When heated, the aerosol-generating section 9 generates aerosol. When a user draws air through the filter section 13, an airflow through the aerosol-generating article 5 (see arrows in FIG. 1) may be created. The airflow may carry the aerosol generated in the heating space 21 towards the user.

In the embodiment of FIG. 1, the heat receiving surface 25 is provided radially outside of the heating space 21. A direction along which the heater 7 emits a flame 8 to heat the heat receiving surface 25 is essentially oriented in a direction perpendicular to the axial direction (direction of extension of the heating chamber 15 and the storage chamber 17).

FIG. 2 shows an alternative embodiment, according to which the heat receiving surface 25 is arranged axially in line with the heating space 21. The heater 7 emits a flame 8 in a direction essentially along the axial direction.

FIG. 4 illustrates another embodiment of an aerosol-generating system 1. The respective aerosol-generating device 3 comprises a tube extending along the axial direction and defining a heating chamber 15 having a heating space 21 therein. An aerosol-generating article 5 may be inserted into the heating space 21 along an insertion direction 19 that is parallel to the axial direction. In the illustrated embodiment, the aerosol-generating article 5 essentially only comprises the aerosol-generating section 9. However, the aerosol-generating article 5 could also comprise additional sections, such as the spacer section 11 and the filter section 13. The aerosol-generating device 3 comprises a heat protection sleeve 27 that allows a user to hold the aerosol-generating device 3 without risking injury or inconvenience due to a high temperature of the aerosol-generating device 3. As indicated by the double arrow in the lower part of FIG. 4, the heat protection sleeve 27 may be slid with respect to the tube defining the heating chamber 15. A heater 7, such as a conventional cigarette heater, may be used to heat a heat receiving surface 25. The heat receiving surface 25 according to the embodiment of FIG. 4 is provided radially outside of the heating space 21 receiving the aerosol-generating section 9. In FIG. 4, the heater 7 is not inserted into or attached to the aerosol-generating device 3.

FIGS. 5, 6, and 7 show cross-sectional views through different embodiments of the heating chamber 15. The left parts of FIGS. 5, 6 and 7 show sectional views through the heating chamber 15 with the sectional plane being parallel to the axial direction. The right parts of FIGS. 5, 6 and 7 show sectional views through the respective heating chamber 15 with the sectional plane being perpendicular to the axial direction. The heating chambers of FIGS. 5, 6 and 7 may, for example, be part of the aerosol-generating devices 3 of FIGS. 1 and 4.

In FIGS. 5, 6 and 7, the heating chamber 15 comprises multiple layers circumferentially surrounding the heating space 21. An outer heat conduction body 29 forms an outer layer of the heating chamber 15. The heat receiving surface 25 is a part of a radially outer surface of the outer heat conduction body 29. Radially inside of the outer heat conduction body 29, there is heat storage body 31 forming a layer circumferentially surrounding the heating space 21. Radially inside of the heat storage body 31, there is an inner heat conduction body 33 circumferentially surrounding the heating space 21.

A material of the heat storage body 31 has a higher specific heat capacity than a material of the inner heat conduction body 33 and a material of the outer heat conduction body 29. The material of the outer heat conduction body 29 and the material of the inner heat conduction body 33 have higher thermal conductivities than the material of the heat storage body 31. The material of the heat storage body 31 may, for example, be glass or metal. One or both of the material of the inner heat conduction body 33 and the material of the outer heat conduction body 29 may be a metal, such as copper, brass or aluminum, for example.

When the heat receiving surface 25 is heated, the heat is efficiently guided radially inside towards the heat storage body 31 by the outer heat conduction body 29. The heat storage body 31, due to its high specific heat capacity, may serve as a buffer taking up comparatively large amounts of heat and giving the heat up over time to heat the heating space 21 and the aerosol-generating section 9 provided therein. The inner heat conduction body 33 forms an inner surface of the heating chamber 15 defining the heating space 21. The inner heat conduction body 33 efficiently conducts heat from the heat storage body 31 towards the heating space 21 and the aerosol-generating section 9 provided therein.

In FIG. 5, the outer heat conduction body 29, the heat storage body 31, and the inner heat conduction body 33 are symmetrical with respect to the axial direction. The outer heat conduction body 29, the heat storage body 31, and the inner heat conduction body 33 form concentric sleeves circumferentially surrounding the heating space 21.

In FIG. 6, the heat storage body 31 and the inner heat conduction body 33 correspond to the heat storage body 31 and the inner heat conduction body 33 of FIG. 5. The outer heat conduction body 29, however, is not symmetrical with respect to the axial direction. A thickness of the outer heat conduction body 29 varies along both the circumferential direction and the axial direction. The thickness of the outer heat conduction body 29 is highest at the heat receiving surface 25. In particular, the thickness of the outer heat conduction body 29 is highest at the center of the heat receiving surface 25. With increasing distance from the center of the heat receiving surface 25, both along the axial direction and along the circumferential direction, the thickness of the outer heat conduction body 29 decreases.

Due to the different thickness of the outer heat conduction body 29 at different locations, a thermal resistance for heat transport through the outer heat conduction body 29, and thus through the walls of the heating chamber 15, along a radial direction is different for different locations. Due to the highest thickness of the outer heat conduction body 29 at the heat receiving surface 25, in particular at the center of the heat receiving surface 25, the thermal resistance for heat transport through the outer heat conduction layer 29 along the radial direction is highest at the heat receiving surface 25. This may counteract an inhomogeneous temperature distribution within the heating space 21 by having a reduced thermal resistance for heat transport at locations that are farther away from the heat receiving surface 25 and would therefore normally receive less heat.

In FIG. 7, the heat storage body 31 and the inner heat conduction body 33 correspond to the heat storage body 31 and the inner heat conduction body 33 of FIGS. 5 and 6. The outer heat conduction body 29 comprises channels 35 formed in the outer heat conduction body 29. The channels 35 may form flow paths for heated air. A flow cross-section of the channels 35 may vary along at least one of the axial direction and the circumferential direction. A flow cross-section of the channels 35 may be larger in regions farther away from a center of the heat receiving surface 25 to facilitate flow of hot air to those regions.

FIG. 8 shows a cross-sectional view of an aerosol-generating system 1 in which the heat receiving surface 25 is axially aligned with the heating space 21, substantially in line with the embodiment of FIG. 2. In the embodiment of FIG. 8, the heat storage body 31 is axially aligned with the heating space 21. The heat storage body 31 is provided downstream of the heating space 21 with respect to the insertion direction 19. An outer surface of the heat storage body 31 forms the heat receiving surface 25. In the embodiment of FIG. 8, no outer heat conduction body 29 is provided. However, as an alternative, an outer heat conduction body 29 could be provided downstream of the heat storage body 25 with respect to the insertion direction 19.

Between the heat storage body 31 and the heating space 21, an inner heat conduction body 33 is provided. The inner heat conduction body 33 comprises a plate extending essentially perpendicular to the axial direction between the heat storage body 31 and the heating space 21. Further, the inner heat conduction body 33 comprises a cylindrical sleeve part 37 circumferentially surrounding the heating space 21. Further, the inner heat conduction body 33 comprises a protrusion 39 extending into the heating space 21. The protrusion 39 is configured to immerse into the aerosol-generating section 9 of the aerosol-generating article 5.

In the embodiment of FIG. 8, the heater 7 is integrated into the aerosol-generating device 3. The heater 7 comprises a gas tank 41 supplying gas for a flame 8 heating the heat receiving surface 25.

FIG. 9 shows another embodiment of an aerosol-generating system 1. The left part of FIG. 9 shows a sectional view of the system 1 with the sectional plane being parallel to the axial direction. The right part of FIG. 9 shows a sectional view of the system 1 with the sectional plane being perpendicular to the axial direction.

The heater 7 of the system 1 of FIG. 9 is configured to generate a plurality of flames 8 for heating the heat receiving surface 25. As shown in the left part of FIG. 9, some of the flames 8 are spaced along the axial direction to provide improved heat distribution along the axial direction. As shown in the right part of FIG. 9, some of the flames 8 are generated at locations that are spaced along the circumferential direction to distribute heating along the circumferential direction. The heater 7 may be an integral part of the aerosol-generating device 3. The heater 7 may be combined with the aerosol-generating device 3. The heater 7 may be received in a heater receiving section 23 of the aerosol-generating device 3.

FIG. 10 shows an aerosol-generating system 1 according to an embodiment that is largely similar to the embodiment shown in FIG. 1. The heat receiving surface 25 in this embodiment is radially outside the heating space 21. Alternatively, the heat receiving surface 25 could be aligned with the heating space 21 along the axial direction as shown in FIG. 2, for example.

The heater 7 in FIG. 10 is a conventional cigarette lighter removably received in the heater receiving section 23 of the aerosol-generating device 3. Alternatively, the heater 7 could be fixedly integrated into the aerosol-generating device 3.

The aerosol-generating device 3 comprises an ignition mechanism 45 configured to ignite gas released from a gas tank 41 of the heater 7. The ignition mechanism 45 is an integral part of the aerosol-generating device 3. The ignition mechanism 45 is accessible from outside to provide a convenient way of igniting the gas, even if the heater 7 is received in the heater receiving part 23. The heater 7 itself may comprise another ignition mechanism, which may not be accessible when the heater 7 is received in the heater receiving part 23. The ignition mechanism 45 of the aerosol-generating device 3 may function in the same manner as an ignition mechanism of a conventional cigarette lighter.

In FIG. 10, the aerosol-generating device 3 further comprises a heater actuation mechanism 47 configured to act on a gas release button 50 of the heater 7. The heater actuation mechanism 47 allows a user to press the gas release button 50 of the heater 7 even when the heater 7 is received in the heater receiving section 23 and the gas release button 50 is not directly accessible. The heater actuation mechanism 47 may be pressed down by a user to press the gas release button 50 to release gas. When the gas release button 50 of the heater 7 is no longer pressed down, it returns into its initial position and release of gas is stopped.

FIG. 11 shows the heater actuation mechanism 47 in more detail. The heater actuation mechanism 47 comprises an engagement element 49 configured to slide up and down along a sliding element 51 in the form of a rod or bar. A spring element 53 biases the engagement element 49 towards the gas release button 50. A stop 53 is provided at the sliding element 51 to limit the movement of the engagement element 49 towards the gas release button 50. The sliding element 51 is itself is slidingly guided in the aerosol-generating device 3. In FIG. 11, the sliding element 51 may slide up and down. A restoration element 55 biases the sliding element 51 upwards. In the operational situation shown in FIG. 11, the sliding element 51 is in an upper position, which corresponds to a non-engaging configuration of the heater actuation mechanism 47. In the non-engaging configuration of the heater actuation mechanism 47, the engagement element 49 does not press the gas release button 50 (due to the stop 53).

To operate the heater 7 to generate heat, a user may move the sliding element 51 downwards by moving an operating element 57 connected to the sliding element 51. As indicated with arrows in FIG. 11, the operating element 57 is moved downwards, thereby moving the sliding element 51 downwards. This causes the stop 53 to move downwards and allows the engagement element 49 to also move downwards due to the force generated from the spring element 53 to press the gas release button 50.

When the engagement element 49 presses the gas release button 50 to release gas, the heater actuation mechanism 47 is in an engaging configuration. When the user again releases the operating element 57, the restoration element 55 moves the sliding element 51 upwards. At some point, the stop 53 comes in contact with the engagement element 49 and moves the engagement element 49 upwards, thereby releasing the gas release button 50 and stopping release of gas. When the engagement element 49 does not press the gas release button 50, the heater actuation mechanism 47 is in a non-engaging configuration.

Return of the heater actuation mechanism 47 to the non-engaging configuration after release of the operating element 57 is delayed by a blocking mechanism 59 only schematically shown in FIG. 11.

FIG. 12 shows an embodiment of the blocking mechanism 59. The left part of FIG. 12 shows what happens when the heater actuation mechanism 47 is moved towards the engaging configuration by pressing the sliding element 51 pressed down. The blocking mechanism 59 comprises a first wheel 61 and a second wheel 63 having a larger diameter than the first wheel 61. The first wheel 61 and the second wheel 63 are rotatable about a common axis. When the sliding element 51 is pressed down, teeth 65 of the sliding element 51 engage teeth of the first wheel 61 so that the first wheel 61 is rotated counterclockwise in FIG. 12.

The second wheel 63 is connected to the first wheel 61 and therefore also rotates counterclockwise in FIG. 12. An optional spring 67 is loaded by rotation of the first wheel 61. Teeth on the outer circumference of the second wheel 63 are in contact with a rocker arm 69, which does not inhibit the second wheel 63 when the second wheel 63 rotates counterclockwise in the direction given by the sliding element 51 moving down. Thus, the blocking mechanism 59 does not inhibit movement of the heater actuation mechanism 47 into the engaging configuration.

The right part of FIG. 12 shows the situation when the sliding element 51 moves upwards after the operating element 57 has been released. Upward movement of the sliding element 51 may be caused by at least one of the restoration element 55 and the spiraling spring 67. For the sliding element 51 to move upwards, the first wheel 61 and the second wheel 63 have to rotate in a clockwise direction due to the engagement of the teeth 65 of the sliding element 51 and the teeth of the first wheel 61. Rotation of the second wheel 63 in the clockwise direction is periodically blocked and released by rocker arm 69, which goes back and forth between the position shown in the right part of FIG. 12 and the position shown in the left part of FIG. 12. Thus, the rocker arm 69 periodically blocks the movement of the sliding element 51. Each position of the rocker arm 69 blocks the second wheel 63 for a short time before moving to the other position. The numerous teeth of the second wheel 63 allow for numerous back and forth motions of the rocker arm 69. Thus, the upwards motion of the sliding element 51 and therefore, return of the heater actuation mechanism 47 into the non-engaging configuration, is delayed. The delay time depends on the layout of the blocking mechanism 59, in particular on the number of teeth of the second wheel 63.

The further the sliding element 51 is pushed down when bringing the heater actuation mechanism 47 into the engaging configuration to activate release of gas, the more the first wheel 61 and the second wheel 63 are rotated, and the more the returning motion of the heater actuation mechanism 47 into the non-engaging configuration is delayed. The degree to which the sliding element 51 is moved downwards by moving the operating element 57, therefore defines different engaging sub-configurations of the heater actuation mechanism 47 which correspond to different delays for returning into the non-engaging configuration upon release of the operating element 57.

FIG. 13 shows another embodiment of the blocking mechanism 59. Again, the sliding element 51 is provided with teeth 65. The blocking mechanism 59 comprises a pivot part 71 that is pivotable about an axis 73. The blocking mechanism 59 further comprises the thermal expansion element 75 attached to a fixed point 77 at one side and to the pivot part 71 at the other side. The pivot part 71 comprises a tooth 79. The teeth 65 of the sliding member 51 and the tooth 79 of the blocking mechanism 59 are shaped such that a downward motion of the sliding element 51 (bringing the heater actuation mechanism 47 into the engaging position) is always possible (see left part of FIG. 13). An upward motion of the sliding element 51 (bringing the heater actuation mechanism 47 into the non-engaging configuration), however, is allowed or prevented depending on the pivot position of the pivot part 71.

The middle part of FIG. 13 shows the situation after the heater actuation mechanism 47 has been brought into the engaging configuration by moving the operating element 57 downwards, thereby moving the sliding element 51 downwards. The heater 7 has been activated to generate a flame 8. The restoration element 55 biases the sliding element 51 upwards towards the non-engaging configuration of the heater actuation mechanism 47. However, upward motion of the sliding element 51 is blocked by engagement between the teeth 65 of the sliding element 51 and the tooth 79 of the pivot part 71. Thus, the heater actuation mechanism 47 remains in the engaging configuration and the heater 7 continues to generate heat.

Due to heat generated by the heater 7, the thermal expansion element 75 is heated and therefore expands in length. This causes the pivot part 71 to rotate about the axis 73 as indicated in the right part of FIG. 13. Once the thermal expansion element 75 reaches a predetermined temperature, the length of the thermal expansion element 75 is sufficient to pivot the pivot part 71 so that the tooth 79 of the pivot part 71 disengages from the teeth 65 of the sliding element 51. The sliding element 51 consequently moves upwards, returning the heater actuation mechanism 47 to the non-engaging configuration. Consequently, the gas release button 50 ceases to be pressed by the engagement element 49 and the heater 7 is deactivated.

The blocking mechanism 59 thus holds the heater actuation mechanism 47 in the engaging configuration until the thermal expansion element 75 has been heated to a predetermined temperature and then allows return of the heater actuation mechanism 47 into the non-engaging configuration. The predetermined temperature may be set by appropriately choosing the thermal expansion element 75 and the layout of the blocking mechanism 59.

The thermal expansion element 75 may be provided in the heater receiving section 23 of the aerosol-generating device 3. Thus, the thermal expansion element 75 reacts to a temperature in the heater receiving section 23. Alternatively, the thermal expansion element 75 could be provided at other locations, such as within the heating space 21 or at the heating chamber 15. If required, one or more mechanical links could be provided between the thermal expansion element 75 and the pivot part 71.

In the embodiments of FIGS. 12 and 13, the sliding element 51 of the heater actuation mechanism 47 and the blocking mechanism 59 together form a ratchet mechanism allowing free motion of the heater actuation mechanism 47 into the engaging configuration and selectively blocking a motion of the heater actuation mechanism 47 into the non-engaging configuration.

Alternatively, the blocking mechanism 59 could be configured to selectively block a motion of the heater actuation mechanism 47 from the non-engaging configuration into the engaging configuration. This could, for example, be achieved by changing the orientation of the teeth 65 of the sliding element 51. The blocking mechanism 59 could delay a movement of the heater actuation mechanism 47 from the non-engaging configuration into the engaging configuration to prevent overheating of the heating space 21. For example, the blocking mechanism 59 could prevent a user form immediately bringing the heater actuation mechanism 47 back into the engaging configuration after the heater actuation mechanism 47 has just returned into the non-engaging configuration. The blocking mechanism 59 could be configured to allow a movement of the heater actuation mechanism 47 into the engaging configuration only if a temperature of the thermal expansion element 75 of the blocking mechanism 59 is below a predetermined temperature to prevent overheating, for example.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. An aerosol-generating device comprising:
an axially extending heating chamber configured to at least partially receive an aerosol-generating article; and
a heater actuation mechanism configured to move between an engaging configuration and a non-engaging configuration;
wherein the heater actuation mechanism is configured to act on a heater in the engaging configuration to operate the heater to generate heat;
wherein the heater actuation mechanism is configured to not act on the heater in the non-engaging configuration to stop generation of the heat by the heater;
wherein the heater actuation mechanism comprises an operating element configured to be moved to move the heater actuation mechanism from the non-engaging configuration into the engaging configuration; and
wherein the aerosol-generating device further comprises a blocking mechanism configured to temporarily block a movement of the heater actuation mechanism from the engaging configuration into the non-engaging configuration or from the non-engaging configuration into the engaging configuration.

2. The aerosol-generating according to claim 1, wherein the blocking mechanism is configured to temporarily block the movement of the heater actuation mechanism from the engaging configuration into the non-engaging configuration, thereby delaying movement of the heater actuation mechanism from the engaging configuration into the non-engaging configuration.

3. The aerosol-generating device according to claim 1, wherein the heater actuation mechanism comprises a restoration element providing a mechanical force configured to move the heater actuation mechanism towards the non-engaging configuration.

4. The aerosol-generating device according to claim 1, wherein the engaging configuration comprises a plurality of engaging sub-configurations of the heater actuation mechanism and the operating element allows a user to selectively bring the heater actuation mechanism into any one of the engaging sub-configurations, and wherein the blocking mechanism is configured to delay return of the heater actuation mechanism from the respective engaging sub-configuration into the non-engaging configuration by different times for the different engaging sub-configurations.

5. The aerosol-generating device according to claim 1, wherein the blocking mechanism comprises a movable part configured to move between a release position, in which it allows movement of the heater actuation mechanism towards at least one of the non-engaging configuration and the engaging configuration, and a blocking position, in which is blocks movement of the heater actuation mechanism towards the at least one of the non-engaging configuration and the engaging configuration.

6. The aerosol-generating device according to claim 5, wherein the movable part is configured to move between the release position and the blocking position depending on a temperature.

7. The aerosol-generating device according to claim 5, wherein the blocking mechanism comprises a thermal expansion element configured to move the movable part between the release position and the blocking position depending on a temperature of the thermal expansion element.

8. The aerosol-generating device according to claim 5, wherein the moveable part is configured to periodically move between the release positon and the blocking position to delay the movement of the heater actuation mechanism into the non-engaging configuration or into the engaging configuration.

9. The aerosol-generating device according to claim 1, wherein the heater actuation mechanism and the blocking mechanism together form a ratchet mechanism.

10. An aerosol-generating system comprising:
the aerosol-generating device according to claim 1; and
the heater, wherein the heater is configured to generate heat when acted upon by the heater actuation mechanism and to not generate heat when not acted upon by the heater actuation mechanism.

11. The aerosol-generating system according to claim 10, wherein the heater comprises a gas tank configured to release gas when the heater is acted upon by the heater actuation mechanism and configured to prevent release of gas when the heater is not acted upon by the heater actuation mechanism.

12. A method for generating aerosol, wherein
an operating element is moved along a path in an activation direction, thereby acting on a heater via a heater actuation mechanism;
the heater generates heat in response to being acted upon by the heater actuation mechanism;
the operating element is returned in a motion along the path against the activation direction;
one or more moving parts of a blocking mechanism move to delay return of the operating element; and
the heater ceases to generate heat in response to no longer being acted upon by the heater actuation mechanism.

13. The method according to claim 12, wherein a restoration element builds up a restoration force against the movement of the operating element in response to the operating element being moved in the activation direction.

14. The method according to claim 12, wherein gas is released from a gas tank in response to the heater being acted upon by the heater actuation mechanism, wherein the gas sustains a flame heating a heat receiving surface of an aerosol-generating device at least partially receiving an aerosol-generating article.

15. Use of a change in length of a thermal expansion element caused by a temperature change to extinguish a flame after the flame has heated an aerosol-generating device at least partially receiving an aerosol-generating article.
